(19) United States
(12) Patent Application Publication
(10) Pub. No.: US 2009/0002121 A1
(43) Pub. Date: Jan. 1, 2009

(54) Chip resistor and method for fabricating the same

(75) Inventor: Rong-Tzer TSAI, Kaohsiung (TW)

Correspondence Address: Muncy, Geissler, Olds & Lowe, PLLC, P.O. BOX 1364, FAIRFAX, VA, 22038-1364, US

(73) Assignee: FEEL CHERING ENTERPRISE CO., LTD.

(21) Appl. No.: 12/153,145

(22) Filed: May 14, 2008

(30) Foreign Application Priority Data
Jun. 29, 2007 (TW) 096123664

(51) Int. Cl. H01C 10/00; H01C 17/00

(52) U.S. Cl. 338/195; 29/610.1

(57) ABSTRACT

A chip resistor and method for fabricating the same are disclosed according to the present invention, wherein a thermo-conductive adhesive bonding layer is applied to bond together in face-to-face orientation a substrate with a fixed resistor, and a passivation layer is applied to partially cover the fixed resistor, such that it divides the surface of the fixed resistor into a central covered region and two uncovered regions to form two electrode zones, thereby eliminating unnecessary current transmission impedance as in prior art, as well as efficiently and stably reducing the temperature coefficient of resistance. The bonding design of the substrate and the fixed resistor of the present invention is capable of overcoming the drawback of the high cost of semiconductor processing as exists in the prior art, and provides a simple fabrication process that is capable of increasing process yield and decreasing production costs.

### BACKGROUND OF THE INVENTION

1. Field of the Invention

This invention generally relates to a resistor, and more specifically, to a chip resistor of high precision and low resistance, which has a low temperature coefficient of resistance, and method for fabricating the same

2. Description of Related Art

In accordance with the development trends of microminiaturization and portability of various electronic devices, chip resistors—which are frequently used in circuits for establishing an electric potential difference between two terminals for measurement purposes—are accordingly trending towards microminiaturization as well; and, in order to reduce measurement error as well as raise the detected current value, a reduced temperature coefficient of resistance is desired and resistances of between 0.02Ω to 10Ω having a high power capability with permissible powers over 0.1 W are commonly demanded. However, printing and coating techniques, which are presently the most commonly applied fabrication techniques of the prior arts, have practical disadvantages that hinder mass production at low cost.

A chip resistor is disclosed according to the claims of R. O. C. Patent No 350071, wherein, one resistance film, which is a resistant adhesive made of a mixture of glass and electro-conductive particles, is printed on a ceramic substrate by means of a screen printing technique, and, subsequently the resistant film is shaped via the processes of drying, high sintering, and others. Then, a part of the resistant film is melted down to form a trench for adjusting its resistance through a laser “tuning” process, followed by electrodes being formed through an electroplating process. However, the resistant film is formed by means of printing technique, and it is difficult to control the uniformity of thickness of the resistant film. Moreover, due to the effect of broadening the variance at high temperature sintering, the variance of the resistance obtained of the resistant film is great. This is particularly troublesome when the aforementioned chip resistor is applied in a high frequency environment because the resistant film has high porosity and a loose structure and consequently causes high frequency signals to be attenuated greatly, making it undesirable or unsuitable for use in high frequency products.

In another fabrication method that applies the coating technique, a resistant film is formed on a ceramic substrate in a semiconductor fabrication process by means of physical vapor deposition (PVD) or chemical vapor deposition (CVD), such as sputter deposition or evaporation deposition or others. However, since this method of fabricating a chip resistor involves semiconductor fabrication processing, the equipment investment is high and the semiconductor process yield has limitations, making the overall production cost inordinately high, and thus greatly decreasing the competitive advantages of products using resistors formed with this technique. In addition, in the aforementioned semiconductor process, the resistant film is formed in one patterning process via photolithography, wherein a photoresist film has to be removed before proceeding to subsequent processes. However, in the process of removing the photoresist film, the situation of incomplete removal or excessive removal affecting other layers or structures often happens. Consequently, the resistant film is easily exposed such that it can become oxidized or get contaminated, thereby affecting its electrical properties, and accordingly decreasing the process yield.

In order to overcome the aforementioned drawbacks, a fabrication method has been disclosed according to the claims of R. O. C. Patent No. 1237898, wherein, two main electrodes are first separately formed on two ends of one insulated substrate. Next, a resistant film is formed on the upper surface of the insulated substrate by means of thin film deposition, followed by a first passivation layer being formed by means of printing on the resistant film formed in previous step. In this method, the first passivation layer covers at least part of the resistant film between the two main electrodes but uncovers part of resistant film in the neighborhoods of the two main electrodes, wherein the first passivation layer that covers between the two main electrodes extends continuously. Subsequently, the first passivation layer is used as a mask to remove the uncovered resistant film, leaving two plane electrodes formed at the two terminals of the insulated substrate, wherein each separately covers its corresponding main electrode.

However, the foregoing technique still applies semiconductor fabrication processing, so the problems of high cost and poor yield are still unresolved. Also, the coating process for the two extra passivation layers raises costs even more. In addition, the resistant film is indirectly electrically connected to the plane electrodes via the main electrodes, thereby increasing the temperature coefficient of resistance of the resistant film and the main electrodes, with the result being that the temperature coefficient of resistance of the fabricated chip resistor can not be reduced to the required or desired value. Moreover, heat dissipation efficiency is undesirably reduced.

In summary, the aforementioned prior art has the drawbacks of low fabrication process yield, unavoidably high equipment and production costs, inability of reducing the temperature coefficient of resistance to the required value, and others. Therefore, it is a highly urgent issue in the industry to provide a chip resistor and method for fabricating the same that can effectively solve the aforementioned drawbacks.

### SUMMARY OF THE INVENTION

In view of the disadvantages of the prior art mentioned above, it is a primary objective of the present invention to provide a chip resistor that is easy to manufacture and that increases the yield in production.

It is another objective of the present invention to provide a chip resistor and method for fabricating the same that are capable of stably decreasing the temperature coefficient of resistance to a required value.

It is a further objective of the present invention to provide a chip resistor and method for fabricating the same that are capable of decreasing production cost.

To achieve the aforementioned and other objectives, a fabrication method of chip resistor is provided according to the present invention. The fabrication method comprises: providing a substrate and a fixed resistor; bonding together in face-to-face orientation the substrate and the fixed resistor via a thermo-conductive adhesive bonding layer; and partially covering the surface of the fixed resistor with a passivation layer, wherein the passivation layer divides the surface of the fixed resistor into a covered region and two uncovered regions, one on each side of the covered region to form two electrode zones.

In the aforesaid fabrication method, the thermo-conductive adhesive bonding layer can be either a resin adhesive tape or a thermo-conductive adhesive paste, which can be made of epoxy resin, wherein there are no restrictions on the adhering sequence or printing. For instance, in one embodiment, the resin adhesive tape or the thermo-conductive adhesive paste is pre-adhered or pre-printed on a surface of the substrate, and then the fixed resistor and the substrate are bonded together via the resin adhesive tape or the thermo-conductive adhesive paste. In another embodiment, the resin adhesive tape or the thermo-conductive adhesive paste is pre-adhered or pre-printed on surface of the fixed resistor, and then the fixed resistor and the substrate are bonded together via the resin adhesive tape or the thermo-conductive adhesive paste, wherein the thermo-conductive adhesive bonding layer is not limited to applying resin adhesive tape or thermo-conductive adhesive paste, and any adhesive material that is applicable to the bonding process and also has the properties of both thermo-conductivity and insulation is applicable. For instance, the thermo-conductive adhesive bonding layer can be formed by printing a layer of thermo-conductive insulating adhesive, wherein, preferably, the thermo-conductive insulating adhesive is pre-printed on the substrate, and then the substrate and the fixed resistor are bonded together via the thermo-conductive insulating adhesive.

In one embodiment, the passivation layer covers the surface of the central region of the fixed resistor, and consequently separates two opposite sides of the central region of the fixed resistor to form two electrode zones. In another embodiment, two electrodes are further formed separately on the surfaces of the two electrode zones of the fixed resistor, the electrodes being for soldering to, for instance, a circuit board that needs to measure electric potential difference, wherein, preferably, the electrodes are formed on the surfaces of the electrode zones by means of rolling plating.

The basic required property of the applied substrate is that it has an insulative nature. Aside from that, there are no specified restrictions. A ceramic substrate is applicable, for instance. The only basic required property of the resistor is that it is a sheet with a pre-defined resistance. For instance, it can be a metal sheet that has a central punched aperture, or a metal-coated sheet that has groove on its surface, or a metal-printed sheet that has groove on its surface.

In order to achieve the objectives, a chip resistor is further provided by the present invention, wherein the chip resistor comprises: a substrate; a fixed resistor; a thermo-conductive adhesive bonding layer that bonds together in face-to-face orientation the substrate and the fixed resistor together; and a passivation layer, which partially covers the surface of the fixed resistor, and consequently divides the surface of the fixed resistor into a covered region and two uncovered regions, one on each side of the covered region to form two electrode zones.

In summary, the chip resistor and method for fabricating the same of the present invention have following main features: by applying a thermo-conductive adhesive bonding layer to bond together in face-to-face orientation the substrate and the fixed resistor together, the present invention is capable of eliminating the drawback of high cost due to applying semiconductor fabrication processes as in the prior art, and, consequently, achieving the objectives of a simple fabrication process, increased process yield, and decreased production costs. Moreover, the surface of the part of the fixed resistor that is not covered by the passivation layer is divided to directly form two electrode zones, which provide a means for either direct soldering connectivity or for readily forming electrodes that are advantageous for soldering, thereby eliminating unnecessary current transmission impedance as in the prior art, as well as effectively and stably reducing the temperature coefficient of resistance.

### BRIEF DESCRIPTION OF DRAWINGS

The present invention can be more fully understood by reading the following detailed description of the preferred embodiments, with reference made to the accompanying drawings, wherein:

FIGS. 1A through 1F are flow chart diagrams of the first embodiment of the fabrication method of a chip resistor according to the present invention;

FIGS. 2A through 2F are flow chart diagrams of the second embodiment of a fabrication method of a chip resistor according to the present invention; and

FIG. 3 is a diagram illustrating the heat conductance in one application state of a chip resistor of the present invention.

### DETAILED DESCRIPTION OF PREFERRED EMBODIMENTS

The following illustrative embodiments are provided to illustrate the disclosure of the present invention; these and other advantages and effects can be readily understood by those in the art after reading the disclosure of this specification. The present invention can also be performed or applied by other differing embodiments. The details of the specification may be changed on the basis of different points and applications, and numerous modifications and variations can be devised without departing from the spirit of the present invention.

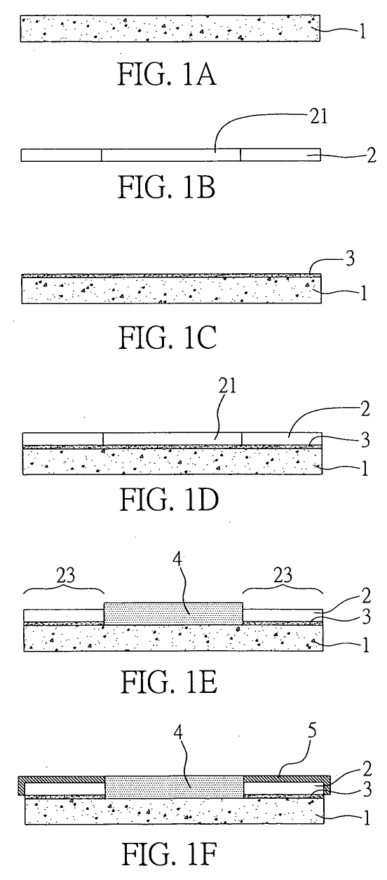

FIGS. 1A through 1F are flow chart diagrams of the first embodiment of the fabrication method for a chip resistor according to the present invention, wherein the fabrication method for a chip resistor provided by the present invention comprises but is not restricted to the following descriptions.

As shown in FIGS. 1A and 1B, first a substrate 1 and a fixed resistor 2 are provided, the said substrate 1 being, for instance, a ceramic substrate that is mainly made of aluminate oxide; however, the basic required property of the substrate is its insulation property, and, aside from that, there are no specific requirements. For instance, in another embodiment, the substrate 2 can be either a glass substrate or a plastic substrate, and is not limited to that stated in the present embodiment. The fixed resistor 2 is, for example, a metal sheet that has a central punched aperture 21, the sheet metal being, for example but not limited to, a metal alloy of copper, manganese, and nickel or tin; and the punched aperture 21 being in the shape of, for example but not limited to, a circle or a rectangle, or various other shapes, as long as the area is easily calculable for converting to resistance. In such a design, the aperture 21 can be pre-formed by means of stamping. Naturally, the basic required property of the said fixed resistor 2 is that its resistance is pre-defined. For example, it can be a metal-coated sheet that has a groove on its surface, or a metal-printed sheet that has a groove on its surface, but it is not limited to these particular examples.

As shown in FIGS. 1C and 1D, next, the substrate 1 and the fixed resistor 2 are bonded together in face-to-face orientation via a thermo-conductive adhesive bonding layer 3, wherein the thermo-conductive adhesive bonding layer 3 can be a resin adhesive tape, which can be made of epoxy resin, and there is no restrictions on the sequence in terms of adhering the bonding layer 3 to either the substrate or the fixed resistor. In the present embodiment, the thermo-conductive adhesive bonding layer 3, for instance, a resin adhesive tape, is pre-adhered on the top surface of the substrate 1, as shown in FIG. 1C, and then the fixed resistor 2 and the substrate 1 are bonded together via the thermo-conductive adhesive bonding layer 3, as shown in FIG. 1D; Certainly, the thermo-conductive adhesive bonding layer 3 is not limited to the application of resin adhesive tape, and any adhesive material that is applicable to the bonding process and also has the properties of both thermo-conductivity and insulation is applicable. For instance, the thermo-conductive adhesive bonding layer 3 can also be formed by printing a layer of thermo-conductive insulating adhesive, wherein, preferably, the thermo-conductive insulating adhesive is pre-printed on the substrate 1, and then the substrate 1 and the fixed resistor 2 are bonded together via the thermo-conductive insulating adhesive.

As shown in FIG. 1E, next, a passivation layer 4 is formed to partially cover the surface of the fixed resistor 2, and consequently divide the surface of the fixed resistor 2 into a region covered by the passivation layer 4 and two opposed regions not covered by the passivation layer 4 to form two electrode zones 23. With this step, a basic chip resistor is completed, wherein the basic required property of said passivation layer 4 is that it provides an insulation purpose, and, in the present embodiment, an insulating material, such as epoxy resin or others, is applied to cover the central region of the fixed resistor 2, including the top and lateral surfaces, by means of coating, and consequently form the two electrode zones 23 on two sides of the fixed resistor 2 oppositely divided by the central region. In one practical application, the two electrode zones 23 formed by dividing the fixed resistor 2 are capable of being directly soldering to an external device, for instance, of being directly soldered to a preset circuits of a circuit board.

As shown in FIG. 1F, in order to provide convenience for soldering in subsequent practical application, an electrode 5 can be separately formed on each of the two electrode zones 23 of the fixed resistor 2, thus providing a means for soldering to, for instance, a circuit board that needs to measure electric potential difference. In a preferred embodiment, the electrodes are formed on the electrode zones by means of rolling plating, but the formation method is not herein limited; any means that is capable of forming electrodes 5 on the surfaces of the electrode zones 23 is applicable, the basic condition being that no medium is required for connecting between the electrodes 5 and the electrode zone 23. For instance, neither electroplating nor thermo compression bonding needs to use a medium, and, therefore, both are applicable means. And since the electrodes are for providing a convenient means for soldering externally, the electrodes 5 are preferably made of a metal alloy containing tin, for instance, a metal alloy of copper and nickel and tin.

It should be noted herein that all the illustrative diagrams of this embodiment are based on the fabrication method of a single chip resistor, but such embodiments and such a number are not restrictive of the technological ideas of the present invention. For example, any commonly used batch production method can integrate a plurality of the aforesaid ceramic substrates 1 into a matrix pattern, and also integrate a plurality of the aforesaid fixed resistors 2 into a matrix pattern, and, after a plurality of chip resistors are simultaneously completed in subsequent processes, a cutting process can be used to singulate the substrates. Therefore, similar fabrication steps or alternatives that are based on the technological ideas of the present invention should be considered to fall within the scope of the present invention. Moreover, since the applied synchronous process of batch production and cutting is clearly understood by those in the art, there is no need of further description or illustrative diagrams herein.

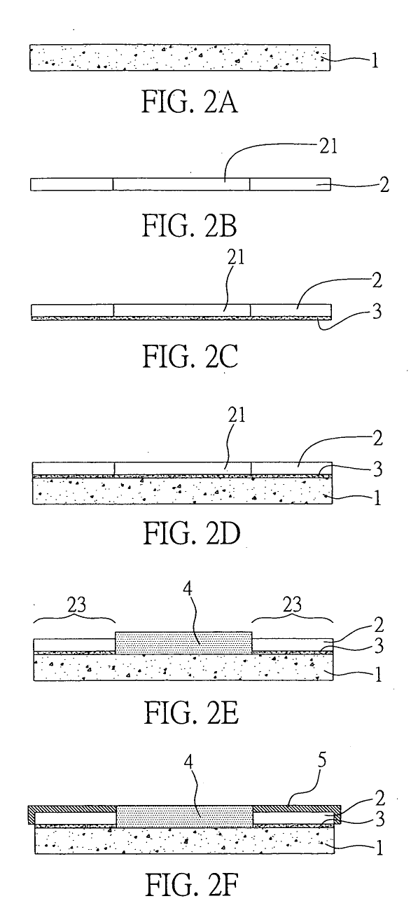

Please refer to FIGS. 2A through 2F which are flow chart diagrams of the second embodiment of a fabrication method for a chip resistor of the present invention; wherein, the disclosed fabrication method of a chip resistor comprises steps mostly similar to that of the previously disclosed first embodiment. In particular, there is no change in the fabricated structure of the chip resistor, and, in order to simplify the illustrative description of the present embodiment, identical elements will adopt the same labels. In the description provided, for the most part, only dissimilar features are described in detail.

As shown in FIGS. 2A and 2B, first, a substrate 1 and one fixed resistor 2 are provided, wherein the characteristics of both said substrate 1 and said fixed resistor 2 are the same as those of the first embodiment, thus these details not repeated.

As shown in FIGS. 2C and 2D, next, the substrate 1 and the fixed resistor 2 are bonded together in face-to-face orientation via a thermo-conductive adhesive bonding layer 3, wherein the thermo-conductive adhesive bonding layer 3 can be a resin adhesive tape, such as an epoxy resin, and there are no restrictions on the sequence of applying the adhesive bonding layer, i.e., in terms of whether the adhesive bonding layer is first applied to the resistor 2 or the substrate 1. In the present embodiment, the thermo-conductive adhesive bonding layer 3 (such as a resin adhesive tape) is adhered on the surface of the fixed resistor 2, and then the fixed resistor 2 and the substrate 1 are bonded together via the thermo-conductive adhesive bonding layer 3, wherein the properties of the thermo-conductive adhesive bonding layer 3 are the same as that of the first embodiment, and, therefore, need not be described separately.

As shown in FIGS. 2E and 2F, the subsequent step of forming a passivation layer 4, and, according to practical demands, the step of separately forming an electrode 5 on the surface of each of the two electrode zones 23, as well as the properties and variations of the passivation layer 4 and electrode 5, are all the same as those of the first embodiment, and, therefore, need not be detailed separately.

In review, as shown in FIGS. 1E and 2E, the present invention provides a chip resistor, which comprises: a substrate 1; a fixed resistor 2; a thermo-conductive adhesive bonding layer 3 that bonds the substrate 1 and the fixed resistor 2 together in face-to-face orientation; and a passivation layer 4 that partially covers the fixed resistor 2, wherein the passivation layer 4 divides the surface of the fixed resistor 2 into a covered region and two opposed uncovered regions with the covered region therebetween, thus forming two electrode zones 23.

The properties and structural variations of the said substrate 1, the said resistor 2, the said thermo-conductive adhesive bonding layer 3, and the said passivation layer 4 are all the same as those of the previously disclosed fabrication methods; therefore, the details are not repeated herein. In addition, the chip resistor of the present invention, as shown in FIG. 1F or 2F, can further comprise electrodes 5, which are separately formed on the surfaces of the two electrode zones 23.

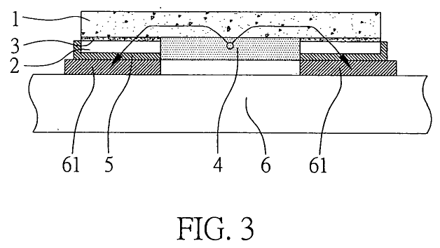

FIG. 3 is a diagram illustrating heat conduction in one application of the chip resistor provided by the present invention while being applied to an external device in an upside down orientation. Referring to FIG. 3, the electrodes 5 on the surfaces of the two electrode zones of the chip resistor are capable of being soldered to corresponding circuit contacts 61 of the circuit of an external device 6, for example, a circuit board. In accordance with the structural design of the aforesaid chip resistor, the electrodes 5 are directly connected to the fixed resistor 2. Therefore, when the fixed resistor 2 generates heat during operating, thermo-conductive paths are available as indicated by the direction arrows in the figure. The passivation layer 4 provides an obstructive effect and, consequently, the thermo-conductive path forms in the direction of the substrate 1 since it possesses better thermo conductivity. From the substrate, even better heat-conductive paths exist from the substrate 1 to the circuit contacts 61 via the electrodes 5 on the two terminals of the fixed resistor 2. Therefore, heat can be dissipated via the substrate 1 and, at the same time, be directly conducted into the printed circuit board of the external device 6 via the circuit contacts, thereby preventing heat from being more directly dissipated from the passivation layer 4, which could cause burning of the external device 6, for instance, a circuit board. Consequently, this design avoids immoderate variations of the temperature coefficient of resistance caused by an increasing temperature of the electrodes 5 and the fixed resistor 2, making such a resistor design applicable to products needing or having extremely low resistance.

In summary, the chip resistor and method for fabricating the same provided by the present invention apply a thermo-conductive adhesive bonding layer to the substrate and the resistor together in a face-to-face orientation, thereby eliminating the drawback of the high cost of applying semiconductor fabrication processing as in prior art, and, consequently, achieving the objectives of a simple fabrication process, increasing fabrication process yield, and decreasing costs. In addition, the part of the fixed resistor not covered by the passivation layer forms two electrode zones with the covered region therebetween, the electrode zones capable of being utilized as a base for forming electrodes for soldering purposes. Alternately, the electrode zones can be utilized as electrodes by themselves for direct soldering, thereby eliminating unnecessary current transmission impedance as in prior art, and, also efficiently and stably reducing the temperature coefficient of resistance. Therefore, the chip resistor and the method for fabrication the same provided by the present invention have overcome the drawbacks of the prior art, thus conforming to the patent application requirements of industrial utility, novelty, and advancement.

The foregoing descriptions of the detailed embodiments are only illustrated to disclose the features and functions of the present invention and are not restrictive of the scope of the present invention. It should be understood to those in the art that all modifications and variations according to the spirit and principle in the disclosure of the present invention should fall within the scope of the appended claims.

What is claimed is:

1. A fabrication method of a chip resistor, which comprises:
providing a substrate and a fixed resistor;
bonding in face-to-face orientation the substrate and the fixed resistor together via a thermo-conductive adhesive bonding layer; and
partially covering the surface of a region of the fixed resistor with a passivation layer such that the passivation layer divides the surface of the fixed resistor into a covered region and two opposed uncovered regions with the covered region disposed therebetween, wherein the uncovered regions serve as electrode zones.

2. The fabrication method of the chip resistor of claim 1, wherein, the thermo-conductive adhesive bonding layer is a resin adhesive tape.

3. The fabrication method of the chip resistor of claim 2, wherein the resin adhesive tape is pre-affixed on the substrate, and then the substrate and the fixed resistor are bonded together via the resin adhesive tape.

4. The fabrication method of the chip resistor of claim 2, wherein the resin adhesive tape is pre-affixed on the fixed resistor, and then the fixed resistor and the substrate are bonded together via the resin adhesive tape.

5. The fabrication method of the chip resistor of claim 2, wherein the resin adhesive tape is made of epoxy resin.

6. The fabrication method of the chip resistor of claim 1, wherein the thermo-conductive adhesive bonding layer is formed by printing thermo-conductive insulating adhesive.

7. The fabrication method of the chip resistor of claim 6, wherein the thermo-conductive insulating adhesive is pre-printed on the substrate, and then the substrate and the fixed resistor are bonded together via the thermo-conductive insulating adhesive.

8. The fabrication method of the chip resistor of claim 1, wherein the passivation layer is located at a central region of the fixed resistor and extends to two opposite edges of the fixed resistor, such that it divides the surface of the fixed resistor into a central region and two opposed surfaces adjacent to the central region, one surface on each side of the central region of the fixed resistor to form the two electrode zones.

9. The fabrication method of the chip resistor of claim 8, further comprising: separately forming two electrodes on the surfaces of the two electrode zones of the fixed resistor.

10. The fabrication method of the chip resistor of claim 9, wherein the electrodes are formed on the surfaces of the electrode zones by means of rolling plating.

11. The fabrication method of the chip resistor of claim 1, wherein the substrate can be one of a ceramic substrate or a glass substrate or a plastic substrate.

12. The fabrication method of the chip resistor of claim 1, wherein the ceramic substrate is made of aluminate oxide.

13. The fabrication method of the chip resistor of claim 1, wherein the fixed resistor is a sheet metal that has a central punched aperture.

14. The fabrication method of the chip resistor of claim 1, wherein the fixed resistor is a metal-coated sheet that has groove on its surface.

15. The fabrication method of the chip resistor of claim 1, wherein the fixed resistor is a metal-printed sheet that has groove on its surface.

16. A chip resistor, comprising:
a substrate;
a fixed resistor;
a thermo-conductive adhesive bonding layer, which bonds in face-to-face orientation the substrate with the fixed resistor; and
a passivation layer, which partially covers the fixed resistor, dividing the surface of the fixed resistor into a covered portion and two opposed uncovered portions to serve as electrode zones.

17. The chip resistor of claim 16, wherein the thermo-conductive adhesive bonding layer is a resin adhesive tape.

18. The chip resistor of claim 17, wherein the resin adhesive tape is made of epoxy resin.

19. The chip resistor of claim 16, wherein the thermo-conductive adhesive bonding layer is formed by printing thermo-conductive insulating adhesive.

20. The chip resistor of claim 16, wherein the passivation layer partially covers the surface of a central region of the fixed resistor such that the passivation layer extends to two opposite edges of the fixed resistor, and consequently divides the fixed resistor into a central covered portion and two uncovered portions opposite each other with the central portion therebetween such that the uncovered portions form electrode zones.

21. The chip resistor of claim 20, further comprising two electrodes that are separately formed on the two electrode zones of the fixed resistor.

22. The chip resistor of claim 16, wherein the substrate is a ceramic substrate or a glass substrate or a plastic substrate.

23. The chip resistor of claim 16, wherein the fixed resistor is a fabricated sheet selected from the group of a sheet metal that has a central punched aperture, a metal-coated sheet that has a groove on its surface, and a metal-printed sheet that has a groove on its surface.
